(19) United States
(12) Patent Application Publication
(10) Pub. No.: US 2026/0058543 A1
(43) Pub. Date: Feb. 26, 2026

(54) ELECTRONIC CONTROL UNIT

(71) Applicant: DENSO CORPORATION, Kariya-city (JP)

(72) Inventor: Kei SANADA, Kariya-city (JP)

(21) Appl. No.: 19/254,594

(22) Filed: Jun. 30, 2025

(30) Foreign Application Priority Data
Aug. 26, 2024 (JP) 2024-144451

(51) Int. Cl. H02M 1/32; H02M 7/44

(52) U.S. Cl. CPC H02M 1/325; H02M 7/44

(57) ABSTRACT

An electronic control unit includes a multiphase power supply, a detector, a first processor, and a second processor. The multiphase power supply includes inductors. The detector performs detection of a short circuit between the inductors of the multiphase power supply, based on an output voltage of the multiphase power supply. The first processor operates with the output voltage of the multiphase power supply. The second processor monitors the first processor. The second processor controls a processing load of the first processor according to a result of the detection performed by the detector.

### CROSS REFERENCE TO RELATED APPLICATION

This application is based on Japanese Patent Application No. 2024-144451 filed on Aug. 26, 2024, the disclosure of which is incorporated herein by reference.

### TECHNICAL FIELD

The present disclosure to an electronic control unit.

### BACKGROUND

In an electronic unit, when a fault occurs in the electronic unit, the electronic unit transitions from a normal mode to a reduced mode to prevent an avalanche fault due to overheating or excessive consumption.

### SUMMARY

The present disclosure describes an electronic control unit that includes a multiphase power supply, a detector, a first processor, and a second processor.

### BRIEF DESCRIPTION OF DRAWINGS

FIG. 1 is a diagram illustrating an electronic control unit according to a first embodiment.

FIG. 2 is a circuit diagram illustrating a multiphase power supply.

FIG. 3 is a perspective view illustrating a coupled inductor.

FIG. 4 is a perspective view illustrating a core.

FIG. 5 is a perspective view illustrating a coil.

FIG. 6 is a diagram illustrating an example of a short circuit between inductors.

FIG. 7 is a diagram illustrating a PWM waveform of each phase and a Vout11 waveform.

FIG. 8 is a block diagram illustrating a detection unit.

FIG. 9 is a timing chart illustrating various signal waveforms.

FIG. 10 is a diagram illustrating a Iout waveform and a Vout1 waveform under normal condition in a reference example.

FIG. 11 is a diagram illustrating the Iout waveform and the Vout1 waveform when an inter-inductor short circuit occurs in the reference example.

FIG. 12 is a flowchart illustrating an example of processing executed by a real-time CPU.

FIG. 13 is a timing chart illustrating the occurrence of an inter-inductor short circuit during high-load processing.

FIG. 14 is a timing chart illustrating the occurrence of an inter-inductor short circuit during low-load processing.

FIG. 15 is a timing chart of the reference example.

FIG. 16 is a flowchart illustrating an example of the processing executed by the real-time CPU in the electronic control unit according to a second embodiment.

### DETAILED DESCRIPTION

An electronic control unit may include a multiphase power supply with multiple inductors and a processor that operates by receiving an output voltage from the multiphase power supply. In the electronic control unit multiphase power supply, performing the process of transitioning to a reduced mode results in a sudden decrease in the processor's processing load. If the processor's processing load fluctuates suddenly when a short circuit occurs between the inductors, the load response tracking may degrade due to the short circuit between the inductors, which may cause the output voltage of the multiphase power supply to exceed the operating guaranteed range of the processor. In other words, there is a possibility that the processor may be abnormal. From the aforementioned perspective, or from other perspectives not mentioned, further improvements may be required for the electronic control unit.

According to an aspect of the present disclosure, an electronic control unit includes a multiphase power supply, a detector, a first processor, and a second processor. The multiphase power supply includes inductors. The detector performs detection of a short circuit between the inductors of the multiphase power supply, based on an output voltage of the multiphase power supply. The first processor operates with the output voltage of the multiphase power supply. The second processor monitors the first processor. The second processor controls a processing load of the first processor according to a result of the detection performed by the detector.

According to the above-mentioned electronic control unit, by including the detection unit and the second processor, it is possible to perform control in response to a short circuit between the inductors. The second processor controls the processing load of the first processor to prevent sudden load fluctuations, for example, when a short circuit occurs between the inductors. Thus, it is possible to suppress the output voltage from exceeding the operating guaranteed range of the first processor.

Hereinafter, multiple embodiments will be described with reference to the drawings. In the respective embodiments, corresponding components are denoted by the same reference numerals, and redundant explanations may be omitted. In cases where only a part of a configuration is described in each embodiment, other parts of the configuration may be applied from the configurations described in other previously explained embodiments. Furthermore, in the description of each embodiment, not only the explicitly stated combinations of configurations but also partial combinations of configurations from multiple embodiments can be made, as long as there are no issues with such combinations.

### First Embodiment

The electronic control unit according to the present embodiment is applicable, for example, to a mobile body. The mobile body includes vehicles such as engine-driven vehicles, hybrid vehicles, and motor-driven vehicles, as well as drones, eVTOLs, aircraft, ships, construction machinery, and agricultural machinery. eVTOL stands for electronic Vertical Take-Off and Landing aircraft. For example, when applied to a vehicle, the electronic control unit controls the equipment installed in the vehicle. The electronic control unit is sometimes referred to as an ECU (Electronic Control Unit). ECU stands for Electronic Control Unit.

The electronic control unit may, for example, execute control related to the movement of a mobile body, or it may execute control different from movement. The electronic control unit may be, for example, an autonomous driving ECU or an ADAS ECU that executes control to assist the driver's driving operations. ADAS stands for Advanced Driving Assistance System. For example, as defined by the Society of Automotive Engineers (SAE International), Levels 3 to 5 correspond to autonomous driving levels, while Levels 1 to 2 correspond to driving assistance levels. The electronic control unit may also be an infotainment ECU or a cockpit ECU. The cockpit ECU controls devices such as the meter device, navigation system, and air conditioning system.

### (Electronic Control Unit)

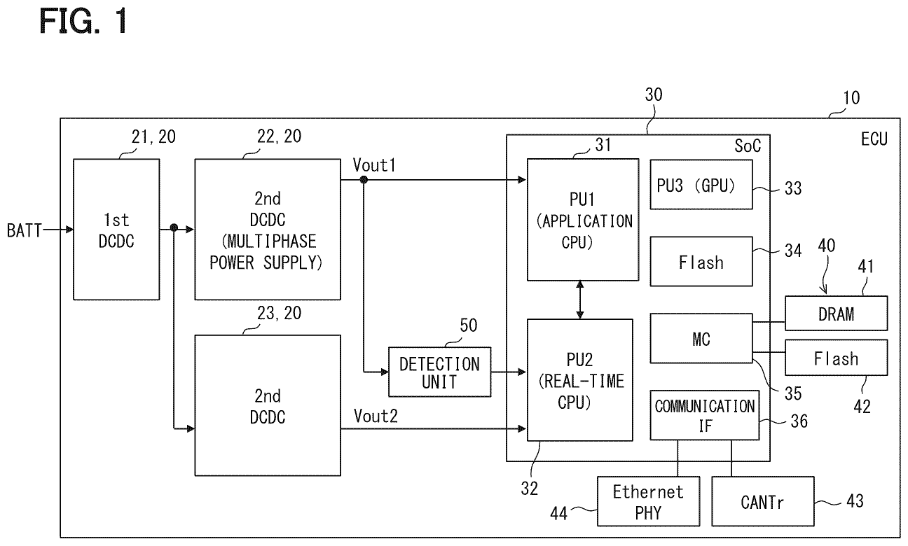

FIG. 1 illustrates an example of an electronic control unit according to the present embodiment. The electronic control unit (ECU) 10 includes a power supply circuit 20, an SoC 30, peripheral devices 40, and a detection unit 50. The detection unit 50 may also be referred to as a detector. In the following, the peripheral devices 40 may be collectively referred to as a peripheral device 40 on some occasions. The power supply circuit 20 includes at least a multiphase power supply. The exemplary electronic control unit 10 is mounted in a vehicle. The power supply circuit 20 includes a primary power supply circuit 21 and secondary power supply circuits 22 and 23. The secondary power supply circuits 22 and 23 are arranged in parallel with each other. Of the secondary power supply circuits 22 and 23, at least the secondary power supply circuit 22 is a multiphase power supply. The exemplary secondary power supply circuits 22 and 23 are both multiphase power supplies. The secondary power supply circuits 22 and 23 are redundant. Hereinafter, the secondary power supply circuit 22 that supplies power to the application CPU 31 may be referred to as the multiphase power supply circuit 22. The power supply circuit 20 only needs to include at least the multiphase power supply circuit 22.

The primary power supply circuit 21 and the secondary power supply circuits 22 and 23 step down the input voltage to a predetermined voltage and output the predetermined voltage. The primary power supply circuit 21 and the secondary power supply circuits 22 and 23 are buck-type DC-DC converters. For example, the primary power supply circuit 21 generates a constant voltage lower than the power supply voltage (for example, 5 V) based on the power supplied from the battery installed in the vehicle. The secondary power supply circuits 22 and 23 each generate a constant voltage lower than the voltage generated by the primary power supply circuit 21 (for example, around 1 V) based on the output of the primary power supply circuit 21. The primary power supply circuit 21 may also be referred to as a primary power source or a primary power supply. The secondary power supply circuits 22 and 23 may also be referred to as core power sources or core power supplies.

The SoC 30 is a single semiconductor chip that incorporates multiple components to realize the functions of a system or device. SoC is an abbreviation for System On Chip. The exemplary SoC 30 includes a processor (PU1) 31, a processor (PU2) 32, a processor (PU3) 33, a flash memory (Flash) 34, a memory controller (MC) 35, a communication interface (IF) 36, and so on. IF is an abbreviation for InterFace. The SoC 30 may also include a wireless communication module, an analog front end, a DSP, and other components. DSP is an abbreviation for Digital Signal Processor. The electronic control unit 10 may be equipped with a SiP instead of or in addition to the SoC 30. SiP is an abbreviation for System in Package.

The peripheral device 40 works in conjunction with the SoC 30 to extend its functionality. The exemplary peripheral devices 40 include DRAM 41, flash memory 42, CAN transceiver (CANTr) 43, and Ethernet PHY 44. DRAM is an abbreviation for Dynamic Random Access Memory. CAN is an abbreviation for Controller Area Network. PHY is an abbreviation for Physical Layer Device. At least some of the peripheral devices 40 may be integrated into the SoC 30. CAN is a registered trademark. Ethernet is a registered trademark.

The processors 31, 32, and 33 are processors that operate by receiving power (electricity) supplied from the power supply circuit 20. In the exemplary SoC 30, the processor 31 is an application CPU that executes an operating system (OS) and applications. The processor 31 is responsible for system control within the SoC 30. The processor 32 is a real-time CPU that executes tasks requiring real-time performance. The processor 32 monitors the operation of at least the processor 31. The processor 32 may execute processing equivalent to that of the processor 31. In other words, the processor 32 may be redundantly provided with respect to the processor 31. The processor 33 is a GPU that performs tasks such as video data processing. CPU stands for Central Processing Unit. GPU stands for Graphics Processing Unit.

The processor 31 operates by receiving power supply from the secondary power supply circuit 22. The processor 32 may receive power supply from either the secondary power supply circuit 22 or the secondary power supply circuit 23. As an example, it may be preferable that processor 32 is configured to operate by receiving power supply from a different power source than processor 31, specifically from the secondary power supply circuit 23. GPU 33 may receive power supply from either the secondary power supply circuit 22 or the secondary power supply circuit 23. GPU 33 may receive power supply from a secondary power supply circuit other than the secondary power supply circuits 22 and 23.

The core voltages of processors 31, 32, and 33 are around 1 V (for example, less than 1 V), and the load current is several tens of amperes or more (for example, 100 A or more). To accommodate such low voltage and high current, the electronic control unit 10 includes multiphase power supplies as the secondary power supply circuits 22 and 23. The multiphase power supply steps down the input voltage to a voltage corresponding to the core voltages of processors 31, 32, and 33, and outputs it. By using a multiphase power supply, it is possible to accommodate the higher performance of the processors 31, 32, and 33, which is necessary for improvements in autonomous driving levels and the evolution of infotainment functions, particularly supporting autonomous driving level 3 and above.

The processors 31, 32, and 33 execute predetermined control processing by running programs stored in the storage while utilizing the temporary storage function of the memory. The memory includes, for example, RAM. RAM stands for Random Access Memory. The memory may include cache and registers. The storage is, for example, ROM. ROM stands for Read Only Memory. The storage may also be an HDD, SSD, or other similar devices. The storage is a non-transitory tangible storage medium that non-temporarily stores programs and data readable by a computer. In the exemplary electronic control unit 10, DRAM 41 corresponds to the memory (RAM). The flash memories 34 and 42 correspond to the storage (ROM). A part of the control program is stored in the flash memory 34 built into the SoC, and another part of the control program is stored in the external flash memory 42.

The memory controller 35 performs operations such as reading, writing, and refreshing the data in the DRAM 41. The memory controller 35 manages the data exchange between the processors 31, 32, and 33 and the flash memories 34 and 42.

The communication interface 36 performs data conversion and other tasks to exchange data between the processors 31, 32, and 33 and the physical layer device. In the exemplary electronic control unit 10, the physical layer devices are the CAN transceiver 43 and the Ethernet PHY 44. The CAN transceiver 43 enables bidirectional communication between the CAN bus (not shown) and the SoC 30 by mutually converting the electrical characteristics between the CAN bus and the SoC 30. The CAN transceiver 43 plays the role of converting digital signals into the electrical signals of the CAN bus and, conversely, converting signals from the CAN bus back into digital signals. The Ethernet PHY 44 is a hardware circuit that mutually converts analog signals and MAC digital signals for communication conforming to Ethernet standards. MAC stands for Media Access Controller. The Ethernet PHY 44 plays the role of converting digital data into analog signals for transmission through cables and converting received analog signals back into digital data.

The detection unit 50 detects shorts occurring between inductors that are included in the multiphase power supply. The detection unit 50 detects a short circuit occurring between different inductors 25 based on the output voltage Vout1 of the multiphase power supply that is included in the secondary power supply circuit 22. The detection unit 50 may be provided outside the secondary power supply circuit 22, as illustrated, or it may be integrated within the secondary power supply circuit 22. The electronic control unit 10 may have a detection unit with a configuration similar to the detection unit 50, which detects a short circuit occurring between different inductors of the secondary power supply circuit 23 based on the output voltage Vout2 of the multiphase power supply that is included in the secondary power supply circuit 23. Details of the detection unit 50 will be described later.

### (Multiphase Power Supply)

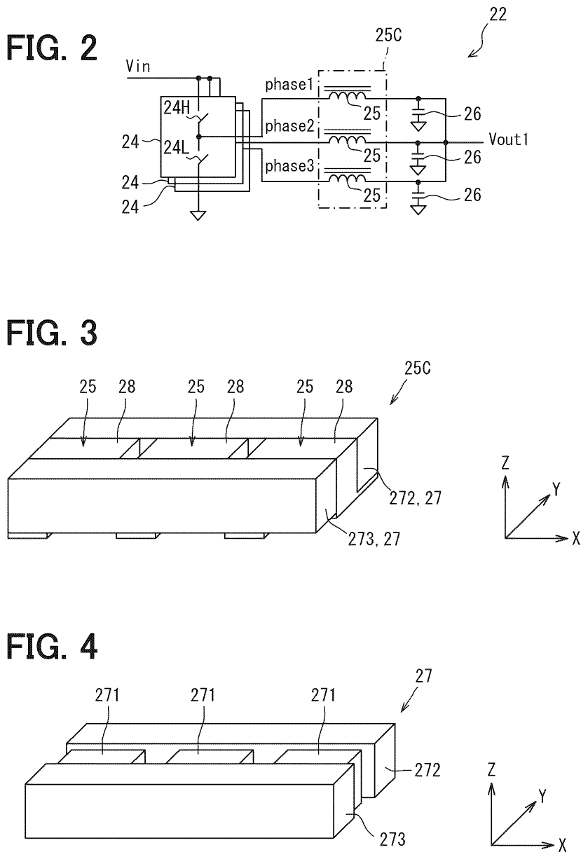

FIG. 2 is a circuit diagram illustrating a multiphase power supply. For convenience, FIG. 2 shows some of the drivers in a simplified manner. The multiphase power supply circuit 22 shown in FIG. 2 that is included in a secondary power supply circuit that provides power to the processor 31 as described above. The multiphase power supply circuit 22 includes multiple drivers 24, multiple inductors 25 provided corresponding to the drivers 24, and a capacitor 26. The multiphase power supply circuit 22 has multiple phases. Phases may also be referred to as stages or channels. In cases where the secondary power supply circuit 23 is a multiphase power supply, it may have the same configuration as the multiphase power supply circuit 22.

The driver 24 includes switching elements 24H and 24L. The switching elements 24H and 24L may be, for example, MOSFETs or IGBTs. The switching elements 24H and 24L may also be bipolar transistors. MOSFET stands for Metal Oxide Semiconductor Field Effect Transistor. IGBT stands for Insulated Gate Bipolar Transistor. The switching elements 24H and 24L are connected in series between the power supply line, to which the input voltage Vin is applied, and the ground (GND) line, with the switching element 24H on the high-side. The input voltage Vin is the output of the primary power supply circuit 21.

One end of the inductor 25 is connected to the connection point (midpoint) of the switching elements 24H and 24L. The other end of the inductor 25 is connected to the output line. The inductor 25 is provided individually with respect to the driver 24. The drivers 24 and the inductors 25 of respective phases are connected in parallel with each other. By paralleling, the output current from the multiphase power supply circuit 22, that is, the load current, can be increased. The number of phases is not particularly limited. The exemplified multiphase power supply circuit 22 has three phases.

The capacitor 26 is connected to the output line. The positive terminal of the capacitor 26 is connected to the output line. The negative terminal of the capacitor 26 is connected to ground. The capacitor 26 may be provided individually for each phase, or it may be provided commonly for multiple phases. In the exemplary multiphase power supply circuit 22, the capacitor 26 is provided for each phase.

The multiphase power supply circuit 22 may include a control unit (not shown). The control unit performs voltage mode control, for example, by feedback of the output voltage Vout1, and controls the operation of the driver 24, namely the operation of the switching elements 24H and 24L. The control unit determines the pulse width (duty cycle) of the PWM signal based on the output voltage Vout1 and controls the output voltage Vout1 of the multiphase power supply circuit 22. The control unit may perform current mode control instead of voltage mode control.

The control unit synchronously controls the multiple drivers 24 so that they perform switching operations at different phases from each other. By using multiple phases in this manner, it is possible to effectively increase the switching frequency even if the switching frequencies of the multiple drivers 24 are the same. This allows for the reduction of ripple components in the output voltage Vout1 and improvement in responsiveness. The control unit switches the number of drivers 24 to be operated in the switching mode, i.e., the number of driving phases, according to the load current. The control unit compares the load current with a threshold current and increases and/or decreases the number of driving phases based on the comparison result.

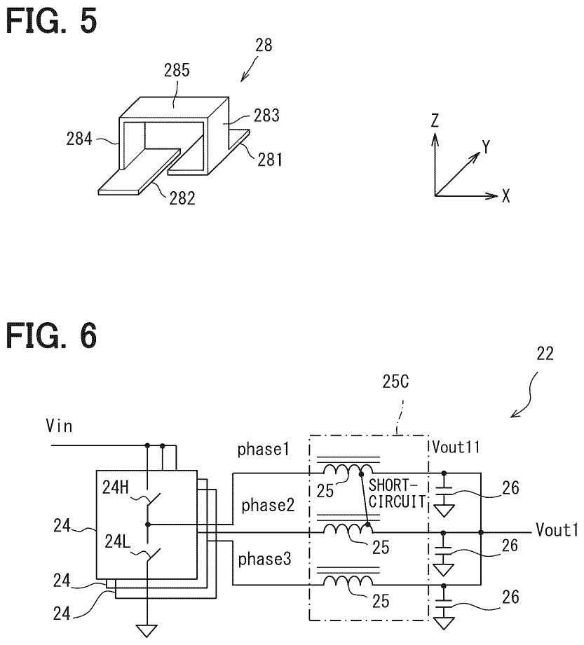

The multiphase power supply circuit 22 may be configured to include multiple individually provided inductors 25. The multiphase power supply circuit 22 may be configured to include an inductor component in which multiple inductors 25 are packaged together. The exemplary multiphase power supply circuit 22 is configured to include a coupled inductor 25C. FIG. 3 is a perspective view showing an example of a coupled inductor. FIG. 4 is a perspective view showing the core. FIG. 5 is a perspective view showing the coil.

In the following, the alignment direction of the coils is indicated as the X direction. A direction orthogonal to the X direction, which is the alignment direction of the two end cores, is indicated as the Y direction. A direction orthogonal to both the X direction and the Y direction is indicated as the Z direction. Unless otherwise specified, the shape viewed in plan from the Z direction, in other words, the shape along the XY plane defined by the X and Y directions, shall be referred to as the planar shape. The plan view from the Z direction may simply be referred to as the plan view.

A single coupled inductor 25C provides multiple inductors 25 that are included in the multiphase power supply circuit 22. As shown in FIGS. 3 to 5, the coupled inductor 25C includes a core 27 and multiple coils 28. The coils 28 are arranged on a single core 27, i.e., a common core 27, and are magnetically coupled to each other. By using the coupled inductor 25C, the magnetic flux between the phases can cancel each other out, thereby reducing the effective inductance.

The core 27 is formed using a magnetic material such as ferrite. The core 27 functions as a magnetic circuit. The core 27 includes multiple central cores 271 and end cores 272 and 273. The core 27 may be formed from a single component, or it may be configured by combining multiple components. The core 27 has a coil 28 inserted through it. The central core 271 is provided individually for the coil 28. The coil 28 is wound around the central core 271. The central core 271 extends in the Y direction. The multiple central cores 271 are arranged in the X direction with a predetermined spacing between them. The exemplary core 27 has three central cores 271. Each central core 271 is approximately rectangular parallelepiped in shape. The three central cores 271 have the same shape as each other.

The end cores 272 and 273 are arranged to face each other in the Y direction. The end cores 272 and 273 have a central core 271 positioned between them. The end cores 272 and 273 extend in the X direction, which is the alignment direction of the multiple central cores 271. One end of each of the multiple central cores 271 is connected to the end core 272, and the other end of each of the multiple central cores 271 is connected to the end core 273. The end cores 272 and 273 magnetically connect the multiple central cores 271. The illustrated end cores 272 and 273 have the same shape as each other. The end cores 272 and 273 have a substantially rectangular parallelepiped shape with the X direction as the longitudinal direction.

The coil 28 is formed using a metal material with better conductivity, such as copper. The coil 28 is formed by processing a metal plate material, rather than a metal wire material. The metal plate material is sometimes referred to as a metal frame. The multiple coils 28 are formed using the same material and have the same shape as each other. The multiple coils 28 have approximately equal inductance to each other. The multiple coils 28 are aligned in the X direction with a predetermined spacing between them. The multiple coils 28 are aligned in the same orientation. The coil 28 is fixed to the core 27, for example, by adhesive bonding. By bringing adjacent coils 28 closer together, the effect of canceling out magnetic flux can be enhanced. In other words, the effect of reducing the effective inductance can be enhanced.

The coil 28 is formed by bending a metal plate material with a predetermined thickness. The coil 28 (coupled inductor 25C) is mounted on a substrate (not shown). The coil 28 has terminal portions 281 and 282, side wall portions 283 and 284, and an upper wall portion 285. The terminal portions 281 and 282 are external connection terminals in the coil 28. The plate thickness direction of the terminal portions 281 and 282 is approximately parallel to the Z direction. The terminal portions 281 and 282 extend in the Y direction. The illustrated terminal portions 281 and 282 have a substantially planar rectangular shape with the Y direction as the longitudinal direction. The terminal portions 281 and 282 are arranged in the X direction with a predetermined interval between them. A part of the side surface of terminal portion 281 and a part of the side surface of terminal portion 282 face each other in the X direction.

The side wall portion 283 is connected to the portion of terminal portion 281 that faces terminal portion 282. The side wall portion 283 is bent at an angle of approximately 90 degrees relative to the terminal portion 281. The plate thickness direction of the side wall portion 283 is approximately parallel to the X direction. The side wall portion 283 has a width equal to the length of the facing portions of terminal portions 281 and 282, and extends in the Z direction. Similarly, the side wall portion 284 is connected to the portion of terminal portion 282 that faces terminal portion 281. The side wall portion 284 is bent at an angle of approximately 90 degrees relative to the terminal portion 282. The plate thickness direction of the side wall portion 284 is approximately parallel to the X direction. The side wall portion 284 has a width equal to the length of the facing portions of the terminal portions 281 and 282, and extends in the Z direction, which is the same direction as the side wall portion 283. The lower ends of the side wall portions 283 and 284 are connected to the terminal portions 281 and 282.

The upper wall portion 285 bridges the side wall portions 283 and 284. The upper wall portion 285 extends in the X direction. One end of the upper wall portion 285 is connected to the upper end of the side wall portion 283, and the other end is connected to the upper end of the side wall portion 284. The upper wall portion 285 has the same width as the side wall portions 283 and 284.

The opposing sections of the terminal portions 281 and 282, the side wall portions 283 and 284, and the upper wall portion 285 surround the central core 271. The opposing sections of the terminal portions 281 and 282, the side wall portions 283 and 284, and the upper wall portion 285 are mounted on and wrapped around the central core 271. In the extending portions, excluding the opposing sections of the terminal portions 281 and 282, end cores 272 and 273 are arranged.

### (Short Circuit Between Inductors and Ripple Variation)

FIG. 6 is a diagram illustrating an example of a short circuit between inductors. In a configuration having multiple inductors 25, for example, a configuration in which multiple inductors 25 are arranged in a predetermined direction, there is a possibility that a short circuit may occur between adjacent inductors due to the intrusion of conductive foreign matter, migration, and the like. Particularly when using coupled inductors 25C, as mentioned above, bringing adjacent coils 28 closer together makes it more likely for a short circuit to occur between neighboring inductors.

In FIG. 6, a short circuit has occurred between the inductor 25 of phase 1 and the inductor 25 of phase 2 among the three phases. Vout11 shown in FIG. 6 is the output voltage of phase 1.

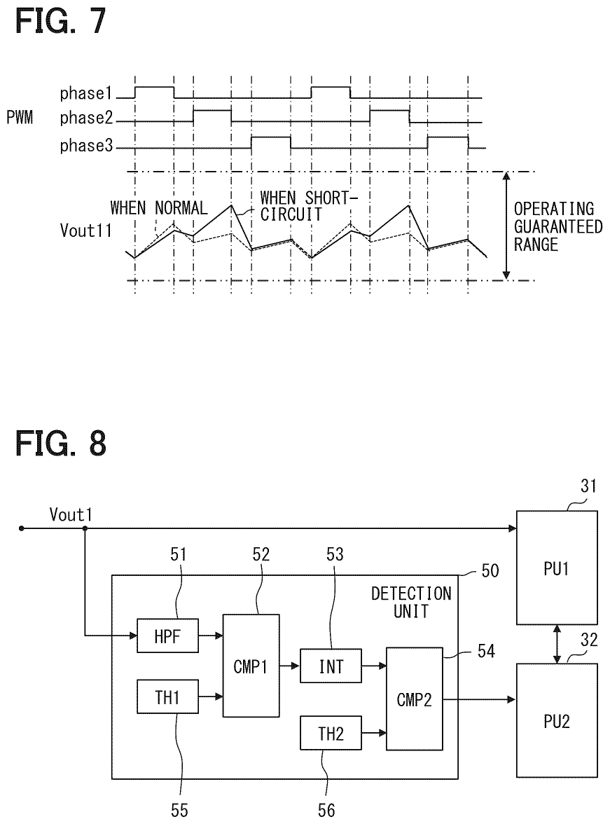

FIG. 7 is a diagram showing the PWM waveform of each phase and the Vout11 waveform. In FIG. 7, the on-period with a predetermined duty ratio is simplified and shown. The PWM waveform indicates the on-period and off-period. FIG. 7 shows the waveforms when a coupled inductor is used. Among the output voltage Vout11, the dashed line indicates the waveform under normal conditions, while the solid line indicates the waveform during a short circuit. The solid line, as shown in FIG. 6, indicates the waveform when a short circuit occurs between the inductors of phase 1 and phase 2. The two-dot chain line for the output voltage Vout11 indicates the overvoltage detection threshold and the undervoltage detection threshold.

Under normal conditions, the output voltage Vout11 rises significantly during the on-period of phase 1. Due to the effects of magnetic coupling, the output voltage Vout11 also rises during the on-period of phase 2 and the on-period of phase 3. The rise during the on-period of phase 2 and the on-period of phase 3 is smaller than the rise during the on-period of phase 1.

When a short circuit occurs between inductors, the output voltage Vout11 rises significantly during the on-period of phase 1 and the on-period of phase 2. Due to the effects of magnetic coupling, the output voltage Vout11 also rises during the on-period of phase 3. The rise during the on-period of phase 3 is smaller than the rise during the on-period of phase 1 and the rise during the on-period of phase 2. Due to the short circuit between inductors, the ripple fluctuation becomes approximately twice as large, but in steady-state conditions without load fluctuations, it is rare for the SoC 30's processor to exceed its guaranteed operating range.

### (Detection Unit)

FIG. 8 is a block diagram illustrating an example of the detection unit. The detection unit 50 detects a short circuit between inductors in the multiphase power supply circuit 22 as described above. At least part of the functions of the detection unit 50 may be implemented in hardware, and at least part of the functions may be implemented in software. The detection unit 50 may include, for example, an analog circuit or a digital circuit. The exemplary detection unit 50 includes a high-pass filter (HPF) 51, a comparator (CMP1) 52, an integrator (INT) 53, and a comparator (CMP2) 54.

The high-pass filter 51 is a filter that allows signals with frequencies higher than a predetermined frequency (cutoff frequency) to pass through. The high-pass filter 51 allows the ripple component, which is the AC component, of the output voltage Vout1 of the multiphase power supply circuit 22 to pass through. The ripple component is sometimes referred to as ripple voltage.

The comparator 52 compares the ripple component with a threshold (TH1) 55 and outputs the comparison result. The comparator 52 determines whether the ripple component is increasing or not. The integrator 53 counts the comparison results from the comparator 52. The integrator 53 counts when the ripple component exceeds the threshold 55. The integrator 53 detects whether the increase in the ripple component is occurring continuously or not. The comparator 54 compares the output of the integrator 53 with a threshold (TH2) 56 and outputs the comparison result. The comparator 54 determines whether a short circuit between inductors has occurred based on the output of the integrator 53. The comparator 54 outputs the comparison result to the processor 32. The comparator 54 outputs a different signal when the output of the integrator 53 exceeds the threshold 56 compared to when the output of the integrator 53 is below the threshold 56.

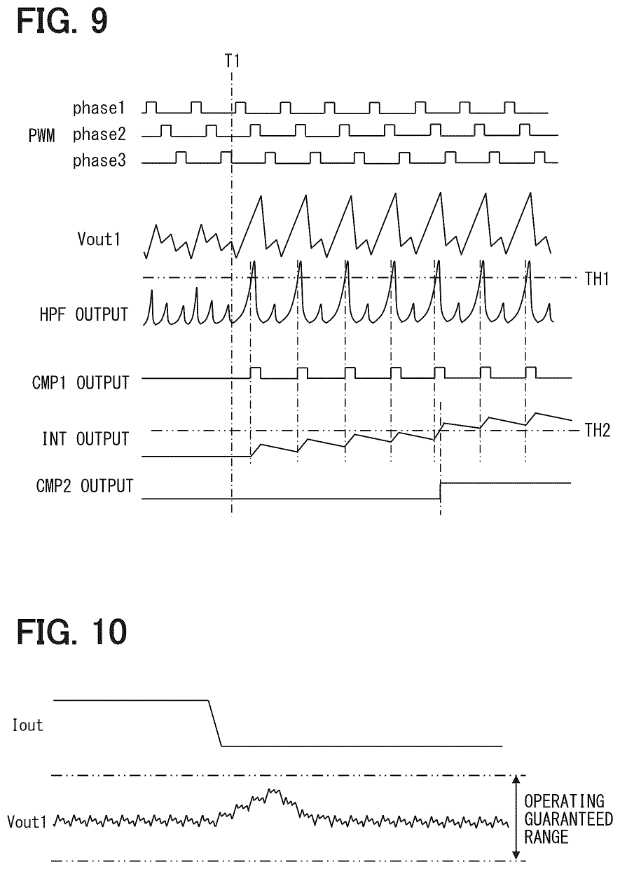

FIG. 9 is a timing chart illustrating an example of various signal waveforms. In FIG. 9, the PWM waveform of each phase, the Vout1 waveform, the output waveform of the high-pass filter (HPC) 51, the output waveform of the comparator (CMP1) 52, the output waveform of the integrator (INT) 53, and the output waveform of the comparator (CMP2) 54 are shown. In FIG. 9, similar to FIG. 7, the on-period with a predetermined duty ratio is simplified and illustrated. Additionally, the Vout1 waveform is simplified and illustrated. TH1 in FIG. 9 indicates the threshold 55 (threshold voltage), and TH2 indicates the threshold 56 (threshold voltage).

FIG. 9 shows the waveforms at timing T1 when a short circuit occurs between the inductor 25 of phase 1 and the inductor 25 of phase 2, similar to FIG. 6. When a short circuit occurs between the inductors of phase 1 and phase 2 at timing T1, current flows through the inductors 25 of both phase 1 and phase 2 during the on-period of phase 1. Additionally, during the on-period of phase 2, current flows through the inductors 25 of both phase 1 and phase 2. Therefore, the fluctuation of Vout1 increases after timing T1.

As a result, the fluctuation in the output of the high-pass filter (HPF) 51 after timing T1, that is, the fluctuation in the ripple component, also becomes larger. Therefore, the output voltage of the high-pass filter 51 periodically exceeds the threshold (TH1) 56 after timing T1. The output voltage of the high-pass filter 51 exceeds the threshold 56 during the on-periods of phase 1 and phase 2.

The comparator (CMP1) 52 outputs an H-level signal indicating an increase in the ripple component when the output voltage of the high-pass filter 51 exceeds the threshold 56. The comparator 52 outputs an L-level signal when the output voltage of the high-pass filter 51 is below the threshold 56. The comparator 52 periodically outputs an H-level signal after timing T1.

The integrator (INT) 53 counts the number of H-level signals output from the comparator 52. The integrator 53 adds voltage when an H-level signal is output from the comparator 52. After the voltage is added, the voltage decreases due to discharge until the next voltage addition. After timing T1, since H-level signals are periodically output from the comparator 52, the output of the integrator 53 increases with each count. When the H-level output from the comparator 52 continues for a predetermined number of times consecutively, the output of the integrator 53 exceeds the threshold (TH2) 56.

The threshold 56 is set to a value larger than the output voltage of the integrator 53 when the number of H-level signals output from the comparator 52 is less than the predetermined number, and smaller than the output of the integrator 53 when the number of H-level signals is equal to or greater than the predetermined number. The predetermined number of times is set to be greater than the number of times the ripple component exceeds the threshold 55 under the maximum fluctuation conditions of the processor (for example, the processor 31) powered by the secondary power supply circuit 22. The maximum fluctuation condition refers to the fluctuation condition under which the variation of the ripple component is at its maximum among the load fluctuations.

The comparator (CMP2) 54 outputs a signal indicating the comparison result to the processor 32. For example, the comparator 54 outputs an H-level signal when the output of the integrator 53 exceeds the threshold (TH2) 56. The comparator 54 outputs an L-level signal when the output of the integrator 53 is below or equal to the threshold 56. The comparator 54 outputs the detection result of the inter-inductor short circuit, indicating the presence or absence of an inter-inductor short circuit. The comparator 54 notifies that an inter-inductor short circuit has occurred when the output of the integrator 53 exceeds the threshold 56. The comparator 54 notifies that an inter-inductor short circuit has not occurred when the output of the integrator 53 is below or equal to the threshold 56. Notification to the processor 32 is made, for example, via communication interfaces such as SPI, I2C, or through direct lines. SPI stands for Serial Peripheral Interface. I2C stands for Inter-Integrated Circuit. The inter-inductor short circuit described in the present disclosure can also be referred to as a short circuit between the inductors.

The configuration of the detection unit 50 is not limited to the aforementioned example. For example, the ripple component (ripple voltage) can be monitored, and if the ripple component is larger compared to normal conditions, it may be determined that a short circuit between inductors has occurred.

### (Influence of Load Variations)

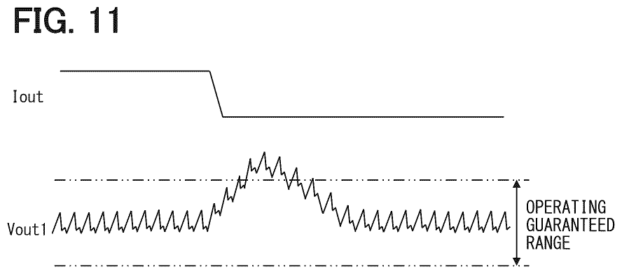

FIGS. 10 and 11 illustrate the impact of load variations in a reference example where the control described later is not executed. FIG. 10 shows the Iout waveform and the Vout1 waveform under normal conditions. FIG. 11 shows the Iout waveform and the Vout1 waveform when a short circuit between inductors has occurred. FIGS. 10 and 11 depict the switching from high-load processing to low-load processing. Iout is the current consumption of processor 31. The multiphase power supply circuit 22 in the reference example is equipped with a coupled inductor 25C.

In the normal condition shown in FIG. 10, even if the consumption current Iout fluctuates rapidly, i.e., the load changes suddenly, the output voltage Vout1 does not exceed the operating guaranteed range of the processor 31. However, in the case of an inter-inductor short circuit shown in FIG. 11, in addition to the increase in ripple components illustrated in FIG. 7, the phase that acts as the coupled inductor 25C is reduced by one due to the inter-inductor short circuit. In other words, the effective inductance increases, and the load response tracking of the output voltage Vout1 degrades. As a result, the load variation characteristics degrade, and there is a possibility that the output voltage Vout1 may exceed the operating guaranteed range of the processor 31.

In the reference example, unlike the electronic control unit 10 illustrated in the present embodiment, no countermeasures for sudden load changes during an inter-inductor short circuit are implemented. Therefore, in cases where the load changes suddenly, such as when switching from autonomous driving mode to manual driving mode, there is a possibility that processor 31 may be abnormal.

### (Control During Inter-Inductor Short Circuit Detection)

As shown in FIG. 1 and FIG. 8, the processor 32 obtains a notification indicating the detection result of an inter-inductor short circuit from the detection unit 50. The processor 32, for example, obtains a notification indicating that an inter-inductor short circuit has occurred. The processor 32 controls the processing load of the processor 31 according to the detection results of the inter-inductor short circuit by the detection unit. When an inter-inductor short circuit occurs, the processor 32 sends a command to the processor 31 to transition to a low-load mode. The processor 32 controls to reduce the processing load of the processor 31 when an inter-inductor short circuit occurs in the multiphase power supply circuit 22. As a result, the processor 31 is able to execute low-load processing when an inter-inductor short circuit occurs. For example, it can switch from autonomous driving to manual driving.

As mentioned above, when an inter-inductor short circuit occurs, the responsiveness of the output voltage Vout1 to load changes degrades, which may cause the output voltage Vout1 to exceed the operating guaranteed range of processor 31. Therefore, the processor 32 obtains a signal indicating the processing load status of the processor 31 and sends a command to the processor 31 to transition to a low-load mode to prevent sudden load fluctuations.

The processing executed by the processor 31 includes low-load processing, high-load processing that has a higher processing load than the low-load processing, and medium-load processing that has a processing load between the low-load and high-load processing. For example, high-load processing corresponds to the autonomous driving mode. Medium-load processing is an autonomous driving mode with some functions restricted compared to high-load processing. Medium-load processing is a mode with a lower level of autonomous driving compared to high-load processing. Low-load processing corresponds to the manual driving mode. The processor 31 is capable of executing at least three different processing load levels. The processor 31 is capable of executing multiple modes with different processing loads, such as high-load mode, medium-load mode, and low-load mode.

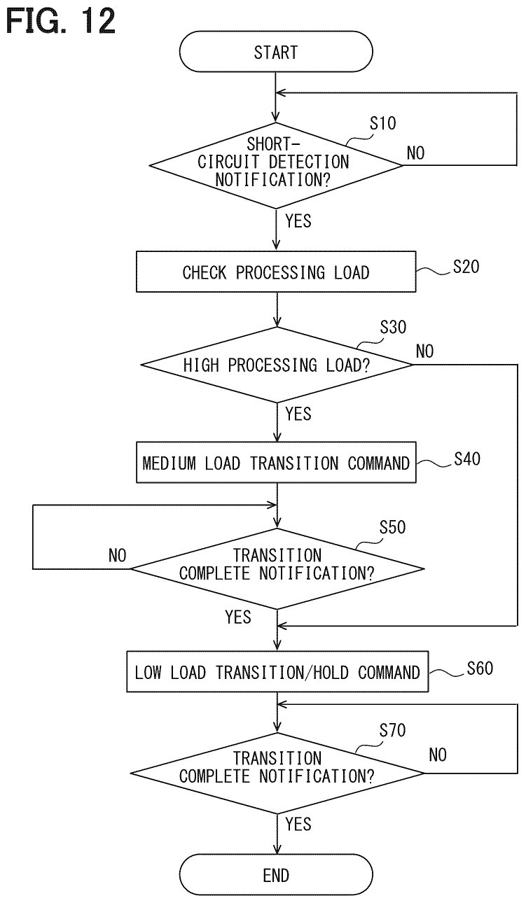

FIG. 12 is a flowchart illustrating an example of processing executed by the real-time CPU. FIG. 12 illustrates the transition process to the low-load mode executed by the processor (PU2) 32 upon detection of an inter-inductor short circuit. The processor 32 executes a process to restrict the processor 31 to the low-load mode upon detection of an inter-inductor short. When the processor 32 is powered on and starts up, the processor 32 executes the following processes.

First, the processor 32 determines whether there is a short-circuit detection notification in S10. The processor 32 repeatedly executes S10 until it receives a notification indicating the detection of an inter-inductor short from the detection unit 50. For example, the processor 32 obtains a notification indicating the detection of an inter-inductor short circuit when the output of the comparator 54 switches to the H level.

Upon obtaining the short-circuit detection notification, the processor 32 then checks the processing load of the processor 31 in S20. The processor 32 requests a response regarding the processing load status from the processor 31. Upon receiving the request, the processor 31 sends a signal indicating the processing load status to the processor 32. For example, the processor 31 sends a signal indicating which mode the processor 31 is currently executing.

The processor 32 then determines whether the processing load on the processor 31 is high in S30. The processor 32 determines whether the processor 31 is executing a high-load process based on the signal indicating the processing load status sent by the processor 31.

If it is determined that the processing load is not high, the processor 32 skips the processes in S40 and S50 and proceeds to S60. If it is determined that the processing load is high, the processor 32 first sends a command to the processor 31 to transition to a medium load mode, in which it executes medium load processing in S40. Upon receiving the medium load transition command, the processor 31 switches from the high load mode, in which the processor 31 executes high-load processing, to the medium load mode. When the mode switching is complete, the processor 31 sends a transition completion notification to the processor 32.

Next, the processor 32 determines whether there is a transition completion notification for the medium load processing in S50. The processor 32 repeatedly executes S50 until it receives the transition completion notification from high load processing to medium load processing.

When the processor 32 receives the transition completion notification for the medium load processing, it sends a command to the processor 31 to transition to the low load mode, in which low load processing is executed in S60. When the processor 31 receives the low load transition command, the processor 31 switches from the medium load mode to the low load mode in which low load processing is executed.

If the processing load of the processor 31 is medium in S30, the processor 32 sends a command to transition to the low load mode in S60. When the processor 31 receives the low load transition command, the processor 31 switches from the medium load mode to the low load mode in which the processor 31 executes low load processing. If the processing load of the processor 31 is low in S30, the processor 32 sends a command to maintain the low load mode in S60. When the processor 31 receives the low load maintenance command, the processor 31 maintains the low load mode. After the processor 31 receives the low load transition command or the low load maintenance command from the processor 32, it maintains the low load mode. When the processor 31 completes the switch to the low load mode or the maintenance of the low load mode, the processor 31 sends a transition completion notification to the processor 32.

Next, the processor 32 determines whether there is a transition completion notification for the low load processing in S70. The processor 32 repeatedly executes S70 until the processor 32 receives the transition completion notification for the low load processing. Upon receiving the transition completion notification for the low load processing, the processor 32 terminates the aforementioned series of processes.

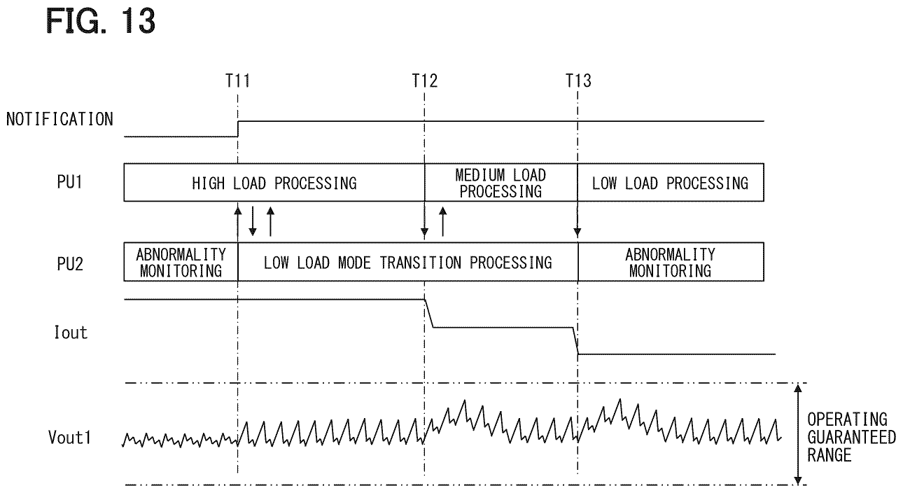

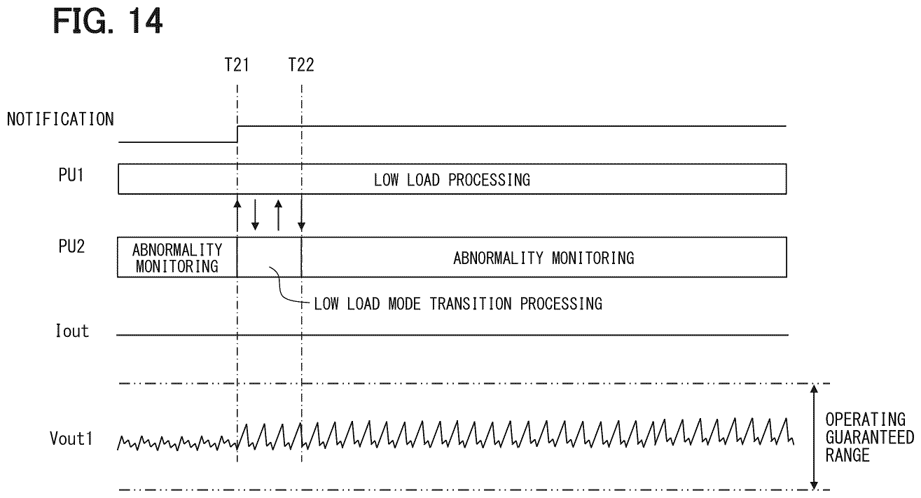

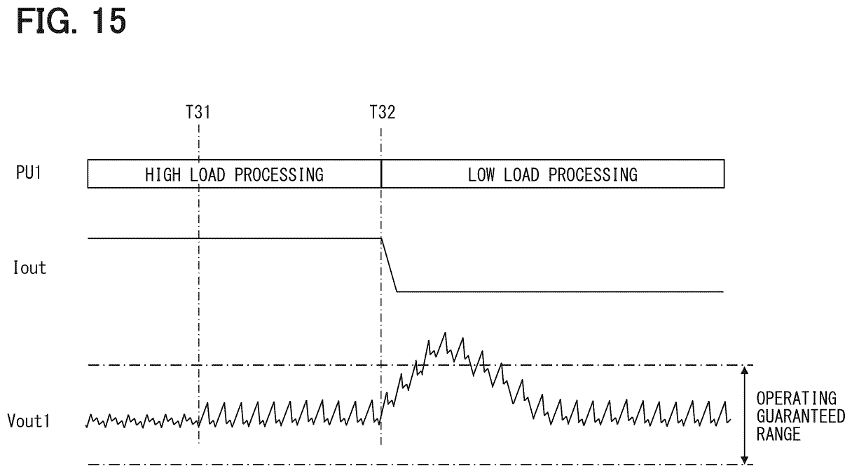

FIG. 13 shows an example of a timing chart when an inter-inductor short circuit occurs during high load processing. FIG. 14 shows an example of a timing chart when an inter-inductor short circuit occurs during low load processing. FIG. 15 shows a timing chart of a reference example. FIG. 15, like FIG. 13, shows a timing chart when an inter-inductor short circuit occurs during high load processing. In FIGS. 13, 14, and 15, PU1 indicates the process (control mode) executed by the processor 31. Iout indicates the current consumption of the processor 31. Vout1 indicates the output voltage of the multiphase power supply circuit 22. In FIGS. 13 and 14, PU2 indicates the process (control mode) executed by the processor 32. The notification is a notification signal of the detection result of the inter-inductor short circuit by the detection unit 50.

In FIG. 13, an inter-inductor short circuit occurs at timing T11. After timing T11, the ripple component of the output voltage Vout1 increases. Upon receiving the notification indicating the detection of an inter-inductor short circuit, the mode executed by processor 32 switches from abnormal monitoring of the processor 31 to low load mode transition processing. As described above, the processor 32 requests the processor 31 to confirm the processing state, and the processor 31 responds to the processor 32 with a signal indicating the processing state. Since the processor 31 is executing high-load processing, the processor 32 sends a transition command to the processor 31 to switch to medium load mode.

Upon receiving the transition command, the processor 31 switches from high-load processing to medium-load processing at timing T12. As a result, the consumption current I_out1 becomes lower than during high-load processing. Although the load response of the output voltage V_out1 degrades due to a short circuit between the inductors, switching from high-load processing to medium-load processing ensures that the output voltage V_out1 does not exceed the operating guaranteed range of the processor 31. At timing T12, the processor 31 sends a notification to the processor 32 indicating the completion of the transition to medium-load processing. Upon receiving the transition completion notification, the processor 32 sends a transition command to the processor 31 to switch to low-load mode.

Upon receiving the transition command, processor 31 switches from medium-load processing to low-load processing at timing T13. As a result, the consumption current I_out1 becomes lower than during medium-load processing. To switch from medium-load processing to low-load processing, the output voltage V_out1 does not exceed the operating guaranteed range of the processor 31. At timing T13, the processor 31 sends a notification to the processor 32 indicating the completion of the transition to low-load processing. Upon receiving the transition completion notification, the processor 32 switches its execution mode from low-load mode transition processing to abnormality monitoring.

In FIG. 14, an inter-inductor short circuit occurs at timing T21. After timing T21, the ripple component of the output voltage V_out1 increases. Upon obtaining the notification indicating the detection of the inter-inductor short circuit, the processor 32 switches its execution mode from anomaly monitoring to low-load mode transition processing. The processor 32 requests the processor 31 to confirm the processing state, and the processor 31 replies to the processor 32 with a signal indicating the processing state. Since the processor 31 is executing low-load processing, the processor 32 sends a command to the processor 31 to maintain the low-load mode.

Upon receiving the hold command, the processor 31 terminates the process of maintaining the low-load processing at timing T22. In order to maintain the low-load processing, the output voltage Vout1 does not exceed the operating guaranteed range of the processor 31. At timing T22, the processor 31 sends a notification to the processor 32 indicating the completion of maintaining the low-load processing. Upon receiving the hold completion notification, the mode executed by the processor 32 switches from the low-load mode transition process to abnormality monitoring.

In FIG. 15, an inductor short circuit occurs at timing T31. After timing T31, the ripple component of the output voltage Vout1 increases. In the reference example shown in FIG. 15, the detection of the inductor short circuit and the processing load control of the processor 31 based on the detection result are not performed. Therefore, the processor 31 continues to execute high-load processing even if an inductor short circuit occurs.

At timing T32, the processor 31 switches from high-load processing to low-load processing. For example, based on user input, the processor 31 switches from a high-load autonomous driving mode to a low-load manual driving mode. As a result, the output current Iout1 decreases sharply. In addition to the increase in ripple components, the load response tracking of the output voltage Vout1 degrades due to the inductor short circuit. Therefore, due to the abrupt load change from high-load to low-load, the output voltage Vout1 increases and exceeds the operating guaranteed range of the processor 31. Consequently, there is a possibility that the processor 31 and, consequently, the SoC 30 may be abnormal.

Additionally, instead of S70, the processor 32 may terminate the series of processes described above by turning off its power. The processor 32 may execute the transition process to the low-load mode triggered by obtaining a notification indicating the detection of an inductor short circuit. The processor 32 may execute at least part of the low-load mode transition process in parallel with the abnormality monitoring process.

### Summary of First Embodiment

The electronic control unit 10 of the present embodiment includes a multiphase power supply circuit 22 having the multiple inductors 25, the detection unit 50, the processor 31 that operates by receiving the output voltage from the multiphase power supply circuit 22, and the processor 32 that monitors the processor 31. The detection unit 50 detects an inductor short circuit based on the output voltage of the multiphase power supply circuit 22. The processor 32 controls the processing load of the processor 31 in response to the detection results of inductor short circuits by the detection unit 50. The processor 31 corresponds to the first processor, and the processor 32 corresponds to the second processor.

According to the disclosed electronic control unit, by including the detection unit 50 and the processor 32, control corresponding to an inductor short circuit is made possible. The processor 32 controls the processing load of the processor 31 to prevent sudden load fluctuations, for example, when an inductor short circuit occurs. As a result, it is possible to prevent the output voltage from exceeding the operating guaranteed range of the processor 31. For example, it is possible to prevent abnormality of the processor 31 and, consequently, abnormality of the SoC 30.

The processor 32 may operate by receiving power from a different power supply (secondary power supply circuit 23) separate from the multiphase power supply circuit 22. As a result, even if an inductor short circuit occurs in the multiphase power supply circuit 22 that supplies power to the processor 31, the processor 32 can still control the processing load of processor 31. The processor 32 can execute low-load mode transition processing.

When the processor 32 receives a notification from the detection unit 50 indicating the detection of an inductor short circuit, the processor 32 may verify the processing load of the processor 31 and control the processing load of the processor 31 based on the verification results. By verifying the processing load of the processor 31 at the time of inductor short circuit detection, the processor 32 can ensure the execution of control that prevents sudden load fluctuations.

If the processing load of the processor 31 is lower than the processing load during high-load processing execution, the processor 32 may control the processor 31 to execute low-load processing. Low-load processing corresponds to first load processing, and high-load processing corresponds to second load processing. Medium-load processing corresponds to third load processing. If the processing load of the processor 31 is medium, switching from medium-load processing to low-load processing results in minimal load fluctuation. If the processing load of the processor 31 is low, the processor 31 maintains low-load processing, resulting in minimal load fluctuation. Therefore, it is possible to prevent the output voltage from exceeding the operating guaranteed range of the processor 31. Additionally, after detecting an inductor short circuit, the processing load of the processor 31 can be immediately reduced.

When the processing load of the processor 31 is at a high load during high-load processing, the processor 32 controls the processor 31 to transition from high-load processing to medium-load processing. Instead of switching directly from high-load processing to low-load processing, the processor 31 first switches to medium-load processing. This prevents the processing load of the processor 31 from fluctuating abruptly, thereby preventing the output voltage from exceeding the operating guaranteed range of the processor 31.

Once the transition to medium-load processing is complete, the processor 32 controls the processor 31 to transition to low-load processing. By switching to low-load processing only after the transition to medium-load processing is complete, it is possible to more reliably prevent abrupt fluctuations in the processing load of processor 31. This can prevent the processing of the processor 31 from switching from medium-load processing to high-load processing. In the event of an inter-inductor short circuit, it is possible to reduce the processing load of the processor 31 while preventing abrupt fluctuations in its processing load.

The multiphase power supply circuit 22 may be arranged in a predetermined direction and include the coupled inductor 25C, which includes the multiple inductors 25 magnetically coupled to each other. By adopting the coupled inductor 25C with such a configuration, it is possible to enhance the effect of magnetic flux cancellation and reduce the effective inductance. On the other hand, adjacent inductors 25 come closer together, making it easier for an inter-inductor short circuit to occur due to foreign objects or other factors. However, by providing the aforementioned detection unit 50, it is possible to detect inter-inductor short circuit. The processor 32 can control the processing load of the processor 31 based on the detection results from the detection unit 50.

### Second Embodiment

This embodiment is a modification based on the basic form of the preceding embodiment, and the descriptions of the preceding embodiment can be applied here as well. In addition to the preceding embodiment, the restriction to low-load mode may be lifted when the inter-inductor short is resolved.

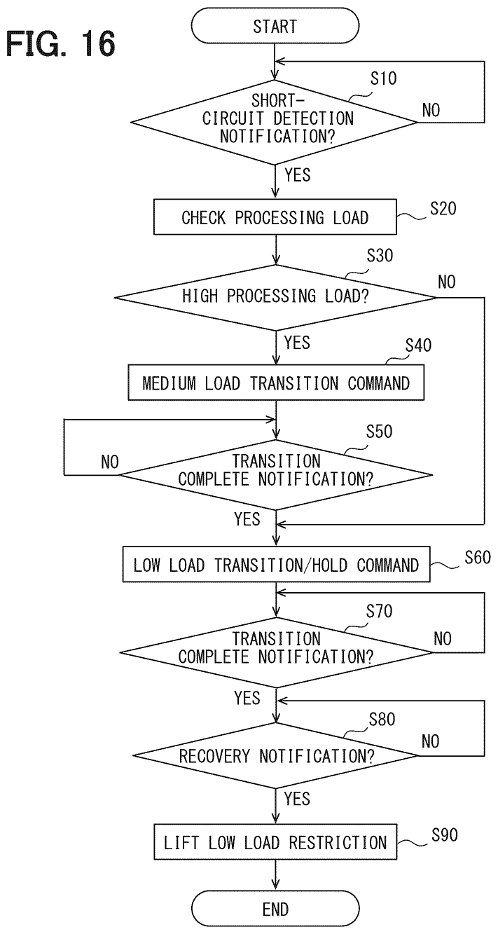

FIG. 16 is a flowchart illustrating an example of the processing executed by the real-time CPU in the electronic control unit according to the present embodiment. FIG. 16 corresponds to FIG. 12. The processing up to S70 is the same as that shown in FIG. 12.

Upon obtaining the transition completion notification to low-load processing in S70, the processor 32 then determines whether there is a recovery notification from the inter-inductor short circuit in S80. The processor 32 determines whether a recovery notification has been obtained. The detection unit 50 outputs a recovery notification to the processor 32 indicating that the inter-inductor short circuit has been resolved, for example, when the output of the comparator 54 switches from the H level to the L level.

The processor 32 repeatedly executes S80 until it obtains the recovery notification. Upon obtaining the recovery notification, the processor 32 lifts the low-load restriction in S90 and concludes the series of processes described above. In S90, the processor 32 sends a command to the processor 31 to lift the restriction on low-load processing. As a result, the processor 31 executes the predetermined processing according to the program without being subject to the processing load restrictions imposed by the processor 32. With the lift of the restrictions, the processor 31 becomes capable of executing processes other than low-load processing. The processor 32, for example, executes the processes from S10 onwards again. The other configurations are the same as those described in the preceding embodiments. It should be noted that the restriction lifting process may be executed separately from the low-load mode transition process.

### Summary of Second Embodiment

The processor 32 may lift the restriction on the processor 31 to limit its processing to low-load processing upon receiving a notification from the detection unit 50 indicating the recovery from an inter-inductor short circuit. When the inter-inductor short circuit in the multiphase power supply circuit 22 is resolved, the effective inductance decreases, and the load response tracking of the output voltage Vout1 improves. By returning the processor 31 to its normal operating state after the inter-inductor short circuit is resolved, it is possible to prevent the output voltage Vout1 from exceeding the operating guaranteed voltage of the processor 31. For example, even when switching from high-load processing to low-load processing, it is possible to prevent the output voltage Vout1 from exceeding the operating guaranteed voltage.

### Other Embodiments

The disclosure in this specification and drawings is not limited to the illustrated embodiments. The disclosure encompasses the illustrated embodiments and variations thereof made by those skilled in the art based on these embodiments. For example, the disclosure is not limited to the combination of components and/or elements shown in the embodiments. The disclosure can be implemented in various combinations. The disclosure can include additional parts that can be added to the embodiments. The disclosure encompasses embodiments where components and/or elements of the embodiments are omitted. The disclosure includes the replacement or combination of components and/or elements between one embodiment and another embodiment. The technical scope of the disclosure is not limited to the described embodiments. The technical scope disclosed is indicated by the descriptions in the present disclosure and should be understood to include all modifications within the meaning and range of equivalency of the descriptions in the present disclosure.

The disclosure in the specification and drawings, etc., is not limited by the descriptions in the present disclosure. The disclosure in the specification and drawings encompasses the technical ideas described in the present disclosure and extends to a more diverse and broader range of technical ideas than those described in the present disclosure. Therefore, without being bound by the descriptions in the present disclosure, various technical ideas can be extracted from the disclosure in the specification and drawings, etc.

When an element or layer is referred to as being “on,” “connected to,” “coupled to,” or “joined to” another element or layer, it can be directly on, connected to, coupled to, or joined to the other element or layer, or there may be intervening elements or layers present. In contrast, when an element is referred to as being “directly on,” “directly connected to,” “directly coupled to,” or “directly joined to” another element or layer, there are no intervening elements or layers present. Other terminology used to describe the relationships between elements should be interpreted in a similar manner (e.g., “between” versus “directly between,” “adjacent to” versus “directly adjacent to,” etc.). As used in this specification, the term “and/or” includes any and all combinations of one or more of the associated listed items. In other words, the phrase “A and/or B” means at least one of A or B.

Spatially relative terms such as “inner,” “outer,” “rear,” “lower,” “upper,” “higher,” and the like are used here to facilitate the description of the relationship of one element or feature to another element or feature as illustrated. Spatially relative terms are intended to encompass different orientations of the device in use or operation, in addition to the orientation depicted in the drawings. For example, if the device in the drawings is turned over, elements described as “below” or “beneath” other elements or features would then be oriented “above” the other elements or features. Therefore, the term “below” can encompass both upward and downward orientations. The device may be oriented in other directions (rotated 90 degrees or in other orientations), and the spatially relative descriptors used in this specification should be interpreted accordingly.

An example in which the power supply circuit 20 includes a primary power supply circuit 21 and a secondary power supply circuit 22 has been shown, but it is not limited to this configuration. An example in which the multiphase power supply circuit 22 forms the secondary power supply circuit has been shown, but it is not limited to this configuration.

What is claimed is:

1. An electronic control unit comprising:
a multiphase power supply including inductors;
a detector configured to perform detection of a short circuit between the inductors of the multiphase power supply, based on an output voltage of the multiphase power supply;
a first processor configured to operate with the output voltage of the multiphase power supply; and
a second processor configured to monitor the first processor, wherein
the second processor is configured to control a processing load of the first processor according to a result of the detection of the short circuit performed by the detector.

2. The electronic control unit according to claim 1, wherein
the second processor is configured to operate with power supplied from another power supply that is different from the multiphase power supply.

3. The electronic control unit according to claim 1, wherein
a mode of processing performed by the first processor includes:
first load processing;
second load processing that has a higher processing load than the first load processing; and
third load processing that has a higher processing load than the first load processing and has a lower processing load than the second load processing, and
the second processor is configured to:
perform checking of the processing load of the first processor in response to receiving a notification from the detector, the notification indicating the detection of the short circuit between the inductors; and
control the processing load of the first processor according to a result of the checking.

4. The electronic control unit according to claim 3, wherein
the second processor is configured to control the first processor to execute the first load processing, on a condition that the result of the checking indicates that a present processing load of the first processor is lower than the processing load of the second load processing.

5. The electronic control unit according to claim 3, wherein
the second processor is configured to switch the mode from the second load processing to the third load processing, on a condition that the result of the checking indicates that a present processing load of the first processor is the processing load of the second load processing.

6. The electronic control unit according to claim 5, wherein
the second processor is configured to switch the mode to the first load processing in response to that switching of the mode to the third load processing is complete.

7. The electronic control unit according to claim 3, wherein
the notification is a first notification,
the second processor is configured to lift restriction that limits the mode to the first load processing, in response to that the second processor receives a second notification from the detector, and
the second notification indicates that the multiphase power supply has recovered from the short circuit between the inductors.

8. The electronic control unit according to claim 1, wherein
the multiphase power supply includes a coupled inductor having the inductors, and
the inductors included in the coupled inductor are aligned in a predetermined direction and are mutually magnetically coupled.
